(19) United States
(12) Patent Application Publication
(10) Pub. No.: US 2023/0202930 A1
(43) Pub. Date: Jun. 29, 2023

(54) ELECTRON-EMITTING CERAMIC

(71) Applicants: FRAUNHOFER-GESELLSCHAFT ZUR FÖRDERUNG DER ANGEWANDTEN FORSCHUNG E.V., München (DE); TECHNISCHE UNIVERSITÄT DRESDEN, Dresden (DE)

(72) Inventors: Katja WÄTZIG, Freital (DE); Christian DROBNY, Wurzen (DE); Martin TAJMAR, Dresden (DE)

(73) Assignees: FRAUNHOFER-GESELLSCHAFT ZUR FÖRDERUNG DER ANGEWANDTEN FORSCHUNG E.V., München (DE); TECHNISCHE UNIVERSITÄT DRESDEN, Dresden (DE)

(21) Appl. No.: 17/912,695

(22) PCT Filed: Mar. 17, 2021
(86) PCT No.: PCT/EP2021/056852

§ 371 Date: Sep. 19, 2022

(30) Foreign Application Priority Data
Mar. 20, 2020 (DE) 10 2020 107 795.5

(51) Int. Cl. C04B 35/44; C04B 41/51

(52) U.S. Cl. CPC C04B 35/44; C04B 41/51; C04B 2235/3222; C04B 2235/408; C04B 2235/404; C04B 2235/96; C04B 2235/77

(57) ABSTRACT

Embodiments are directed to the field of ceramics and relate to electron-emitting ceramics such as those which can be used as cathode material for electron emissions in space flight systems, for example. Embodiments specify an electron-emitting ceramic which has an improved temperature conductivity with a simultaneously continuous electron emission. The electron-emitting ceramic contains at least>70 vol. % C12A7 electride and a proportion of Zr, Hf, V, Nb, Ta, Cr, Mo, W, Mn, Re, Fe, Ru, Os, Ni, Pd, Pt, Cu, Ag, Au, Zn, Cd, In, Sn, Sb, Te, Tl, Pb, or Bi as metal and/or with Ti, wherein the proportion of the metals lies between>0 and<30 vol. %, and the ceramic has a density of at least 85% of the theoretical density of the ceramic and the ceramic contains 0 to maximally 10 vol. % production-specific impurities.

The invention concerns the field of ceramics and relates to electron-emitting ceramics such as those which can be used as cathode material for electron emissions in space flight systems like satellite propulsion devices, for thermionic converters, or field-emission displays, for example.

From EP 165164 B1, an electron-emitting 12CaO·7Al₂O₃ compound (C12A7) and a compound of the same type made therefrom and a method for their production are known.

A mixture of the starting materials Al(OH)₃ and CaCO₃ is either pressed and treated by means of alkali or alkaline earth vapors between 600-800° C. for 4-240 h, or pressed and melted under reducing atmosphere between 1550 and 1650° C. and gradually cooled. The resulting compound exhibits a very good electrical conductivity of>10⁻⁴ S/cm.

As a result of this production, the compound C12A7 made of the starting materials is crystallized in a cage structure, and a portion of the oxygen is present as free oxygen in this cage-like network structure, so that a [Ca₂₄Al₂₈O₆₄]⁴⁺2O²⁻ structure formed. Because of the production under reducing conditions, the free oxygen is exchanged by free electrons, so that a material in the composition of [Ca₂₄Al₂₈O₆₄]⁴⁺4e⁻ is formed, which is an electride.

Electrides are chemical compounds in which the negative charge is present not as an anion, but rather as a free electron (Wikipedia, German-language keyword “Elektrid”).

Furthermore, from WO13191212 A1, an electroluminescent element is known which was produced by a method in which a substrate is coated by means of CVD under a partial pressure of oxygen of<0.1 Pa, for which purpose a target of crystalline C12A7 electride is used. The electroluminescent element is composed of an anode, a light-emitting layer, and a cathode. Between the light-emitting layer and the cathode, an electron-transporting layer that is a thin layer of C12A7 electride is arranged.

From WO 2007/060890 A1, a metallic electron-conducting C12A7 compound and a method for the production thereof are known.

According to U.S. Pat. No. 3,515,932A, a hollow cathode in a chamber with an orifice is known, in which hollow cathode the wall of the chamber is coated with a nickel layer, wherein the nickel contains different oxides in an encapsulated manner. Using a heater, a plasma is generated in the chamber, which plasma flows out of the orifice and strikes the anode arranged in front of said orifice. As a result, a gaseous connection, a plasma bridge, is created between the anode and cathode. Barium oxide, strontium oxide, and calcium oxide can be used as oxides that are encapsulated in nickel.

As a result of the reduction in the work function of the electrons from the coated surface layer in the chamber, lower temperatures for thermal electron emission are achieved.

According to EP0200035 B1, an electron beam apparatus is known which is composed of a chamber, the interior surface of which is composed of a material which has a high secondary electron emission coefficient under bombardment with ions from an incoming ionizable gas so that, when the interior is filled with an ionizable gas plasma, high-energy electrons are emitted from the interior surface by secondary electron emission effects due to bombardment with the ions, and low-energy electrons which are created by collisions between the high-energy electrons and the gas ions are emitted through the aperture.

According to WO 29014/176603 A1, a C12A7 electride hollow cathode with a low work function for electron emission is known.

Furthermore, from U.S. Pat. No. 10,002,738 B1, a method is known for producing a hollow cathode from an emitter ceramic (BaO—CaO—Al₂O₃) which is composed of a porous composite of at least 50 mass % refractory metals that are present such that they are uniformly distributed in a ceramic, wherein the ceramic contains BaO, CaO, and at least Al₂O₃, SmO, or MgO.

In addition, according to T. Yoshizumi et al: Appl. Phys. Express 6 (2013) 015802, a thermionic cathode material is known which is composed of C12A7 electride and metallic Ti at a ratio of 70:30 vol. % (C12A7:Ti). This material exhibits better properties in terms of ductility and electrical conductivity.

Disadvantages of the known C12A7 electride materials are that, because of their poor thermal conductivity, the material is only inadequately heated through, so that thermal stresses occurs, which cause cracks in the material. Thus, for instance, a continuous electron emission is prevented and the long-term stability of the materials is impaired.

The object of the present invention is to specify an electron-emitting ceramic which has an improved temperature conductivity, electrical conductivity, and long-term stability with a simultaneously continuous electron emission.

The object is attained by the invention recited in the patent claims. Advantageous embodiments are the subject of the dependent claims, wherein the invention also includes combinations of the individual dependent patent claims within the meaning of an and-operation, provided that they are not mutually exclusive.

The electron-emitting ceramic contains at least>70 vol. % C12A7 electride and a proportion of Zr, Hf, V, Nb, Ta, Cr, Mo, W, Mn, Re, Fe, Ru, Os, Ni, Pd, Pt, Cu, Ag, Au, Zn, Cd, In, Sn, Sb, Te, Tl, Pb, or Bi as metal individually or as a mixture or compound or alloy of said metals with one another and/or with Ti, wherein the proportion of the metals lies between>0 and <30 vol. %, and the ceramic has a density of at least 85% of the theoretical density of the ceramic and the ceramic contains 0 to maximally 10 vol. % production-specific impurities, dopants, auxiliary materials, and/or additives.

Advantageously, 70 to 90 vol. %, more advantageously 75 to 90 vol. %, C12A7 electride is present in the ceramic in the electron-emitting ceramic.

It is further advantageous if 5 to<30 vol. %, more advantageously 5 to 20 vol. %, and even more advantageously 10 to 15 vol. %, of metals are present in the electron-emitting ceramic.

Likewise advantageously, a percolation network of the metals is formed in the electron-emitting ceramic.

It is also advantageous if, in the electron-emitting ceramic, the density of the ceramic is >95% of the theoretical density of the ceramic.

It is further advantageous if inert metals, more advantageously Mo, W, Nb, Ta, Re, Au, Pt, Pd, are present as metal in the electron-emitting ceramic.

It is likewise advantageous if individual metals or alloys of metals are present as metal in the electron-emitting ceramic.

And it is also advantageous if alkaline earth elements such as Sr and/or Ba are present as production-specific impurities, dopants, auxiliary materials, and/or additives in the electron-emitting ceramic.

With the ceramic according to the invention, it is for the first time possible to specify a ceramic of this type which exhibits improved temperature conductivity and long-term stability with a simultaneously continuous electron emission, and a simple and cost-efficient method for producing a ceramic of this type.

This is achieved by an electron-emitting ceramic which is composed of at least>70 vol. % C12A7 electride.

The compound C12A7 is the oxygen-conducting compound 12CaO·7Al₂O₃ or [Ca₂₄Al₂₈O₆₄]⁴⁺2O²⁻.

C12A7 electride is the electron-conducting compound [Ca₂₄Al₂₈O₆₄]⁴⁺4e⁻.

Advantageously, 70-90 vol. %, more advantageously 75-90 vol. %, C12A7 electride is present in the ceramic.

Furthermore, Zr, Hf, V, Nb, Ta, Cr, Mo, W, Mn, Re, Fe, Ru, Os, Ni, Pd, Pt, Cu, Ag, Au, Zn, Cd, In, Sn, Sb, Te, Tl, Pb, or Bi as metal individually or as a mixture or compound or alloy of said metals with one another and/or with Ti are present as a mandatory constituent of the electron-emitting ceramic according to the invention.

Whenever metals are hereinafter referred to in the solution according to the invention, this shall always be understood as Zr, Hf, V, Nb, Ta, Cr, Mo, W, Mn, Re, Fe, Ru, Os, Ni, Pd, Pt, Cu, Ag, Au, Zn, Cd, In, Sn, Sb, Te, T1, Pb, or Bi as metal individually or as a mixture or compound or alloy of said metals with one another and/or with Ti.

These necessarily present metals in the electron-emitting ceramic according to the invention are present in a proportion between>0 and<30 vol. %, according to the invention.

Advantageously, these metals are present in a proportion of at least 5 vol. % to<30 vol. %, advantageously 5 to 20 vol. %, more advantageously 10 to 15 vol. %.

It is of particular significance for the invention that, in the electron-emitting ceramic according to the invention, such a proportion of metals is present that causes the formation of a percolation network of the metals on the one hand, but on the other hand a lowest possible proportion of metals is still present in the electron-emitting ceramic according to the invention.

If, in the electron-emitting ceramics according to the invention, a percolation boundary or percolation threshold for the formation of a percolation network can be determined using the metals, the proportion of metals in the electron-emitting ceramic according to the invention should exceed the necessary proportion for reaching the percolation boundary or percolation threshold by maximally 10 vol. %, advantageously by maximally 5 vol. %.

The electron-emitting ceramic according to the invention furthermore comprises 0 to maximally 10 vol. % production-specific impurities, dopants, auxiliary materials, and/or additives.

Production-specific impurities, dopants, auxiliary materials, and/or additives of this type can be alkaline earth elements such as Sr and/or Ba.

It is of further significance for the invention that the electron-emitting ceramic according to the invention should have a lowest possible proportion of metals, although a thermal conductivity necessary for the particular application and an increased electrical conductivity should be realized by the metals. Therefore, the composition of the electron-emitting ceramic according to the invention is always supplemented with the necessary proportion of C12A7 electride to reach 100 vol. %, always based on the necessary proportion of metals for the particular application and on the impurities, dopants, auxiliary materials, and/or additives necessary for production.

Based on the composition of the electron-emitting ceramic according to the invention, it is clear that the electron-emitting ceramic according to the invention is a compound material or composite material which is composed of at least two material components, wherein the compound material or composite material according to the invention exhibits a number of improved properties in regard to several properties of the at least two material components.

Additionally, the electron-emitting ceramic according to the invention has a density of at least 85% of the theoretical density of the ceramic.

Advantageously, the density of the ceramic is>95% of the theoretical density of the ceramic.

Also, in regard to the density, both the actual and also the theoretical density, the statements refer to within the scope of the present invention to the density of the overall electron-emitting ceramic according to the invention, which is composed of C12A7 electride and of the metals and possibly of production-specific impurities, dopants, auxiliary materials, and/or additives.

The electron-emitting ceramic according to the invention has a low work function of, for example, <2.8 eV and thereby a very good electrical conductivity for electrons at the same time. Similarly, this ceramic exhibits an increased temperature conductivity compared to the known electron-emitting ceramics, whereby a continuous operation of the systems with the ceramic according to the invention can be realized at lower temperatures.

For example, the electron-emitting ceramic according to the invention can be produced as a hollow cylinder and installed in a hollow cathode and functioning as a highly efficient electron emitter. For this purpose, a propellant gas such as xenon or krypton or argon or helium or other gases flows directly into the hollow cathode and a voltage between the cathode and a hole electrode in front of said hollow cathode ignites a plasma. This leads to an inner heating of the cathode material and simultaneously to a cleaning of the ceramic surface, which is necessary for an efficient electron emission. At the same time, this results in a direct contact of the plasma in the cathode with the ambient plasma, for example by an ion thruster, or the ambient environment in low earth orbit, whereby space charge effects can be overcome, and high currents can thus be realized.

With the electron-emitting ceramic according to the invention, the electrical conductivity through the metallic conductive path at the interface between the ceramic/metal is also significantly improved.

Similarly, with the electron-emitting ceramic according to the invention, a material is in particular provided for cathodes which exhibits material properties as an electron emitter that are different than those known in the prior art and are improved.

It is thereby of particular significance that the positive properties of pure electrides, which among other things are a continuous electron emission, a low work function, a high chemical stability, and a high reactivity, properties that are in particular present even at very low temperatures around absolute zero and for the most part to −40° C., are retained to the most complete extent possible in the solution according to the invention. According to the invention, this is ensured in that the highest possible proportion of C12A7 electride is present in the electron- emitting ceramic according to the invention.

At the same time, however, the more negative properties of pure electrides, such as their poor thermal conductivity, their brittleness, and their lack of ohmic contact with metals, are significantly improved with the solution according to the invention. This is achieved with the lowest possible proportion of metals between>0 and<30 vol. %. With such a low proportion of metals, the percolation boundary of the metals in the electron-emitting ceramic according to the invention is normally exceeded, and a percolation network thus formed, which in particular leads to the improvement of the temperature conductivity, the electrical conductivity, and the long-term stability with a simultaneously continuous electron emission of the electron-emitting ceramic according to the invention.

Another advantage of the electron-emitting ceramic according to the invention is that no heating elements or filaments are needed for the ignition of a plasma or for the operation of the cathode.

The research projects that have led to these results were supported by the European Union.

The invention is explained below in greater detail with the aid of several exemplary embodiments.

### Example 1

CaCO₃ and Al₂O₃ powders are mixed at an amount-of-substance ratio of 12 to 7 and melted at a temperature of 1450° C. The melt is quenched on a brass block, and is comminuted in a vibratory disc mill and by means of wet grinding. During the wet grinding, 29.9 mass % Mo powder, which corresponds to 10 vol. % Mo powder, is added and the mixture is further homogenized. The ground material is then dried, and the powder obtained is pressed into cylindrical discs. The discs are sintered under nitrogen atmosphere in a furnace with a graphite heater at 1350° C. with a holding time of 10 h.

The electron-emitting ceramic obtained has a density of>95% of the theoretical density and, after a dry polishing, can be directly used as cathode for an electron emitter.

To determine the work function of the cathode material, said material is heated under vacuum at 10⁻⁶ Pa to a temperature of 300° C. to 950° C. and the current that flows through the emitted electrons onto an opposing plate is measured at a maximum electric field of 40 V/cm. The work function determined was 2.4-2.8 eV at a measuring temperature of at least 800° C.

The temperature conductivity of the ceramic was 1.5 mm²/s (25° C.) and 1.1 mm²/s (300° C.).

During use of the ceramic as cathode material in a hollow cathode in a satellite propulsion device, it was possible to establish an improvement of the long-term stability with a simultaneously continuous electron emission.

### Example 2

CaCO₃, SrCO₃, and Al₂O₃ powders are mixed at a CaO:SrO:Al₂O₃ amount-of-substance ratio of 11.5:0.5:7 and melted at a temperature of 1450° C. The melt is quenched on a brass block, and is comminuted in a vibratory disc mill and by means of wet grinding. During the wet grinding, 65 mass % W powder, which corresponds to 20 vol. % W powder, is added and the mixture is further homogenized.

The ground material is then dried, and the powder obtained is pressed into cylindrical discs. The discs are sintered under nitrogen atmosphere in a furnace with a graphite heater at 1350° C. with a holding time of 10 h.

The electron-emitting ceramic obtained thus contains as a doping approximately 3.4mass % SrO and has a density of 98% of the theoretical density and, after a dry polishing, can be directly used as cathode for an electron emitter.

To determine the work function of the cathode material, said material is heated under vacuum at 10⁻⁶ Pa to a temperature of 300° C. to 950° C. and the current that flows through the emitted electrons onto an opposing plate is measured at a maximum electric field of 40 V/cm. The work function determined was 2.5 eV at a measuring temperature of at least 800° C.

The temperature conductivity of the ceramic was 2.5 mm²/s (25° C.) and 1.9 mm²/s (300° C.).

During use of the ceramic as cathode material in a satellite propulsion device, it was possible to establish an improvement of the long-term stability with a simultaneously continuous electron emission.

### Example 3

CaCO₃ and Al₂O₃ powders are mixed at an amount-of-substance ratio of 12 to 7 and melted at a temperature of 1450° C. The melt is quenched on a brass block, and is comminuted in a vibratory disc mill and by means of wet grinding. During the wet grinding, 17 mass % Ti-15 Mo alloy powder, which corresponds to 10 vol. % Ti-15 Mo alloy powder, is added and the mixture is further homogenized. The ground material is then dried, and the powder obtained is pressed into cylinders with a length of 20 mm. From the cylinders, hollow cylinders with an outer diameter of 4.5 mm and an inner diameter of 1 mm are fabricated by means of dry green machining. The hollow cylinders are sintered under nitrogen atmosphere in a furnace with a graphite heater at 1350° C. with a holding time of 10 h.

The electron-emitting ceramic obtained has a density of>95% of the theoretical density.

For the generation of an electric plasma, one of the ceramic hollow cylinders is installed in a hollow cathode. The hollow cathode is essentially composed of the hollow cylinder insert, a holder, a gas connection, an insulator, and a keeper. The hollow cathode is positioned with a Hall-effect thruster in a high-vacuum chamber. 100

691 For the operation of the cathode, krypton gas is conducted through the cathode and therefore the hollow cylinder. By applying a potential difference between the hollow cylinder emitter and the keeper, a plasma state is excited in the cathode, wherein a plasma is ignited. The plasma thruster is ignited and operated by applying a positive potential at the anode of the Hall-effect thruster.

During operation of the hollow cathode, a temperature near the electron-emitting hollow cylinder body of approximately 150° C. is reached, which is significantly lower than with conventional electron-emitting materials.

During use of the ceramic as hollow cathode in a satellite propulsion device, it was possible to establish a reduced temperature of the electron source with a simultaneously continuous plasma generation.

1. An electron-emitting ceramic which contains at least>70 vol. % C12A7 electride and a proportion of Zr, Hf, V, Nb, Ta, Cr, Mo, W, Mn, Re, Fe, Ru, Os, Ni, Pd, Pt, Cu, Ag, Au, Zn, Cd, In, Sn, Sb, Te, Tl, Pb, or Bi as metal individually or as a mixture or compound or alloy of said metals with one another and/or with Ti, wherein the proportion of the metals lies between>0 and<30 vol. %, and the ceramic has a density of at least 85% of the theoretical density of the ceramic and the ceramic contains 0 to maximally 10 vol. % production-specific impurities, dopants, auxiliary materials, and/or additives.

2. The electron-emitting ceramic according to claim 1 in which 70 to 90 vol. %, advantageously 75 to 90 vol. %, C12A7 electride is present in the ceramic.

3. The electron-emitting ceramic according to claim 1 in which 5 to<30 vol. %, advantageously 5 to 20 vol. %, more advantageously 10 to 15 vol. %, of metals are present.

4. The electron-emitting ceramic according to claim 1 in which a percolation network of the metals is formed.

5. The electron-emitting ceramic according to claim 1 in which the density of the ceramic is >95% of the theoretical density of the ceramic.

6. The electron-emitting ceramic according to claim 1 in which inert metals, advantageously Mo, W, Nb, Ta, Re, Au, Pt, Pd, are present as metal.

7. The electron-emitting ceramic according to claim 1 in which individual metals or alloys of metals are present as metal.

8. The electron-emitting ceramic according to claim 1 in which alkaline earth elements such as Sr and/or Ba are present as production-specific impurities, dopants, auxiliary materials, and/or additives.
